(19) United States
(12) Patent Application Publication
(10) Pub. No.: US 2026/0087803 A1
(43) Pub. Date: Mar. 26, 2026

(54) MACHINE LEARNING-BASED PROCESSING OF ENVIRONMENTAL DATA WITH TEMPORAL DYNAMICS AND SPATIAL AWARENESS INFORMATION

(71) Applicant: Dell Products L.P., Round Rock, TX (US)

(72) Inventors: Zijia Wang, London (GB); Sanping Li, Beijing (CN); Tianlu Fei, Shanghai (CN); Zhen Jia, Shanghai (CN); Linye Li, Shanghai (CN)

(21) Appl. No.: 18/893,120

(22) Filed: Sep. 23, 2024

(51) Int. Cl. G06V 20/40; G06F 40/40; G06V 10/62; G06V 10/764; G06V 10/77; G06V 10/82; G06V 10/86

(52) U.S. Cl. CPC G06V 20/41; G06F 40/40; G06V 10/764; G06V 10/7715; G06V 10/82; G06V 10/86; G06V 20/44; G06V 10/62

(57) ABSTRACT

An apparatus comprises at least one processing device configured to generate, based on an input prompt, a first data structure comprising a textual task description associated with tasks to be performed in an environment, and to generate, based on video data of the environment, a second data structure comprising temporal dynamics information characterizing changes in spatial features of the environment over time. The at least one processing device is also configured to generate, based on images of the environment, a third data structure comprising spatial relationship information characterizing spatial relationships between objects in the environment, and to determine, utilizing at least one machine learning model that takes as input at least portions of the first, second and third data structures, actions to execute in the environment to achieve the tasks. The at least one processing device is further configured to execute the determined actions in the environment.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering. In some cases, LLMs or other AI and ML models are utilized in producing augmented reality and virtual reality applications, where a user environment (e.g., a real-world environment) is overlayed with digital content or a user environment is replaced with a simulated environment.

### SUMMARY

Illustrative embodiments of the present disclosure provide techniques for machine learning-based processing of environmental data using temporal dynamics and spatial awareness information.

In one embodiment, an apparatus comprises at least one processing device comprising a processor coupled to a memory. The at least one processing device is configured to generate, based at least in part on an obtained input prompt, a first data structure comprising a textual task description associated with one or more tasks to be performed in an environment, and to generate, based at least in part on video data of the environment, a second data structure comprising temporal dynamics information characterizing one or more changes in spatial features of the environment over time. The at least one processing device is also configured to generate, based at least in part on one or more images of the environment, a third data structure comprising spatial relationship information characterizing spatial relationships between two or more objects in the environment, and to determine, utilizing at least one machine learning model that takes as input at least portions of the first, second and third data structures, one or more actions to execute in the environment to achieve the one or more tasks. The at least one processing device is further configured to execute the determined one or more actions in the environment.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based processing of environmental data using temporal dynamics and spatial awareness information in an illustrative embodiment.

FIG. 2 is a flow diagram of an exemplary process for machine learning-based processing of environmental data using temporal dynamics and spatial awareness information in an illustrative embodiment.

FIG. 3 shows a system implementing an artificial intelligence framework incorporating temporal dynamics and spatial awareness features in an illustrative embodiment.

FIG. 4 shows an architecture of an artificial intelligence framework incorporating temporal dynamics and spatial awareness features in an illustrative embodiment.

FIG. 5 shows a system flow for temporal dynamics analysis in an illustrative embodiment.

FIG. 6 shows a system flow for spatial awareness analysis in an illustrative embodiment.

FIG. 7 shows a system flow for combining temporal features, spatial features and encoded text in an Embodied AI framework in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

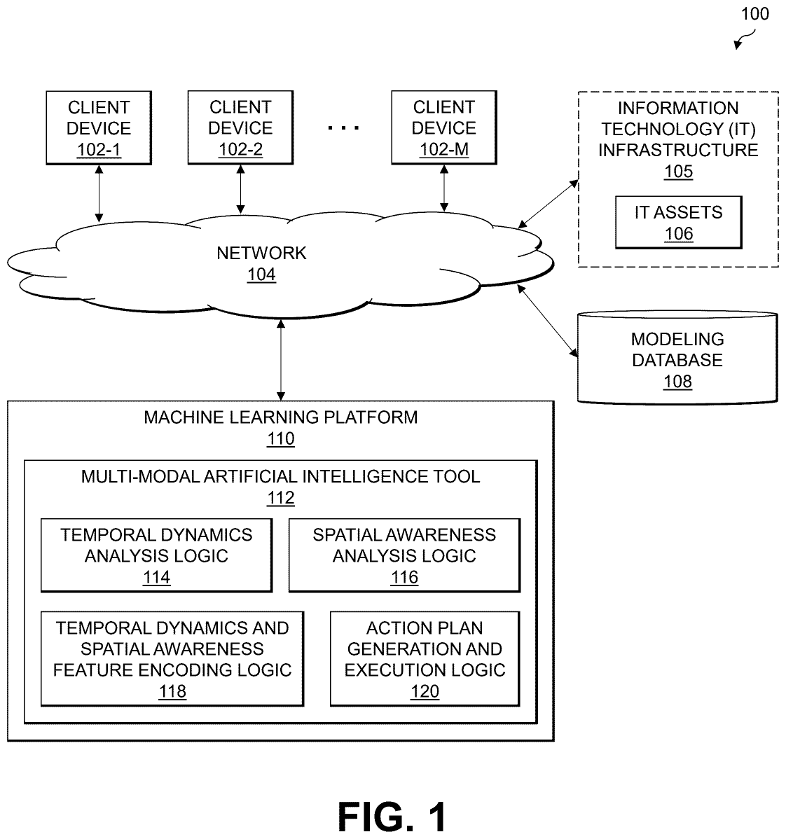

FIG. 1 shows an information processing system 100 configured in accordance with an illustrative embodiment. The information processing system 100 is assumed to be built on at least one processing platform and provides functionality for machine learning-based processing of environmental data using temporal dynamics and spatial awareness information. The information processing system 100 includes a set of client devices 102-1, 102-2, . . . 102-M (collectively, client devices 102) which are coupled to a network 104. Also coupled to the network 104 is an IT machine learning platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the machine learning platform 110 is used for an enterprise system. For example, an enterprise may subscribe to or otherwise utilize the machine learning platform 110 for processing of environmental data (e.g., for an environment such as a physical or virtual environment) using temporal dynamics and spatial awareness information generated for that environment, in order to determine actions to take in the environment (e.g., for achieving one or more tasks that are to be performed by analyzing input prompts from one or more users or other entities which are in or interacting with the environment). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Modeling database 108 is configured to store and record various information that is utilized by the machine learning platform 110. Such information may include, for example, user prompts (e.g., text-based, voice or audio-based using speech-to-text conversion, etc.), model parameters for one or more machine learning models utilized in the machine learning platform 110, video and image data for an environment utilizes in temporal dynamics and spatial awareness analysis, etc. The modeling database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the machine learning platform 110, as well as to support communication between the machine learning platform 110 and other related systems and devices not explicitly shown.

The machine learning platform 110 may be provided as a cloud service that is accessible by one or more of the client devices 102 to allow users thereof to manage action plans for actions to take in environments based on input user prompts for different users of an enterprise, organization or other entity. In some embodiments, the client devices 102 are assumed to be associated with users of an enterprise, organization or other entity that seeks to determine actions to take to achieve one or more tasks within an environment. In some embodiments, the client devices 102 are utilized by members of the same enterprise, organization or other entity that operates the machine learning platform 110. In other embodiments, the client devices 102 are utilized by members of one or more enterprises, organizations or other entities different than the enterprise, organization or other entity that operates the machine learning platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the modeling database 108 and the machine learning platform 110 regarding an environment, tasks to be performed in the environment, actions which are taken in the environment to achieve the tasks, etc. It should be noted that a “host agent” as this term is generally used herein may comprise an automated entity, such as a software entity running on a processing device. Accordingly, a host agent need not be a human entity.

The machine learning platform 110 in the FIG. 1 embodiment is assumed to be implemented using at least one processing device. Each such processing device generally comprises at least one processor and an associated memory, and implements one or more functional modules or logic for controlling certain features of the machine learning platform 110. In the FIG. 1 embodiment, the machine learning platform 110 implements a multi-modal Artificial Intelligence (AI) tool 112. The multi-modal AI tool 112 comprises temporal dynamics analysis logic 114, spatial awareness analysis logic 116, temporal dynamics and spatial awareness feature encoding logic 118, and action plan generation and execution logic 120. The multi-modal AI tool 112 is configured to receive input prompts and to generate text descriptions for tasks to be performed in an environment. The input prompts may be received from users or other entities (e.g., robotic equipment, autonomous vehicles, computing devices, etc.) that are in or which are interacting with the environment. The temporal dynamics analysis logic 114 is configured to utilize video data of the environment to generate temporal dynamics information characterizing changes in spatial features of the environment over time. The spatial awareness analysis logic 116 is configured to utilize images of the environment to generate spatial relationship information characterizing relationships between objects in the environment. The temporal dynamics and spatial awareness feature encoding logic 118 is configured to generate a combined representation or encoding of the textual task description, the temporal dynamics information and the spatial relationship information to use as input to a multi-modal large language model (MLLM) or other machine learning model. The action plan generation and execution logic 120 is configured to input the combined representation or encoding to the MLLM or other machine learning model to determine actions to execute in the environment to achieve the tasks specified in the textual task descriptions, and to execute the determined actions in the environment.

At least portions of the multi-modal AI tool 112, the temporal dynamics analysis logic 114, the spatial awareness analysis logic 116, the temporal dynamics and spatial awareness feature encoding logic 118, and the action plan generation and execution logic 120 may be implemented at least in part in the form of software that is stored in memory and executed by a processor.

It is to be appreciated that the particular arrangement of the client devices 102, the IT infrastructure 105, the modeling database 108 and the machine learning platform 110 illustrated in the FIG. 1 embodiment is presented by way of example only, and alternative arrangements can be used in other embodiments. As discussed above, for example, the machine learning platform 110 (or portions of components thereof, such as one or more of the multi-modal AI tool 112, the temporal dynamics analysis logic 114, the spatial awareness analysis logic 116, the temporal dynamics and spatial awareness feature encoding logic 118, and the action plan generation and execution logic 120) may in some embodiments be implemented internal to the IT infrastructure 105.

The machine learning platform 110 and other portions of the information processing system 100, as will be described in further detail below, may be part of cloud infrastructure.

The machine learning platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the modeling database 108 and the machine learning platform 110 or components thereof (e.g., the multi-modal AI tool 112, the temporal dynamics analysis logic 114, the spatial awareness analysis logic 116, the temporal dynamics and spatial awareness feature encoding logic 118, and the action plan generation and execution logic 120) may be implemented on respective distinct processing platforms, although numerous other arrangements are possible. For example, in some embodiments at least portions of the machine learning platform 110 and one or more of the client devices 102, the IT infrastructure 105, the IT assets 106 and/or the modeling database 108 are implemented on the same processing platform. A given client device (e.g., 102-1) can therefore be implemented at least in part within at least one processing platform that implements at least a portion of the machine learning platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the modeling database 108 and the machine learning platform 110, or portions or components thereof, to reside in different data centers. Numerous other distributed implementations are possible. The machine learning platform 110 can also be implemented in a distributed manner across multiple data centers.

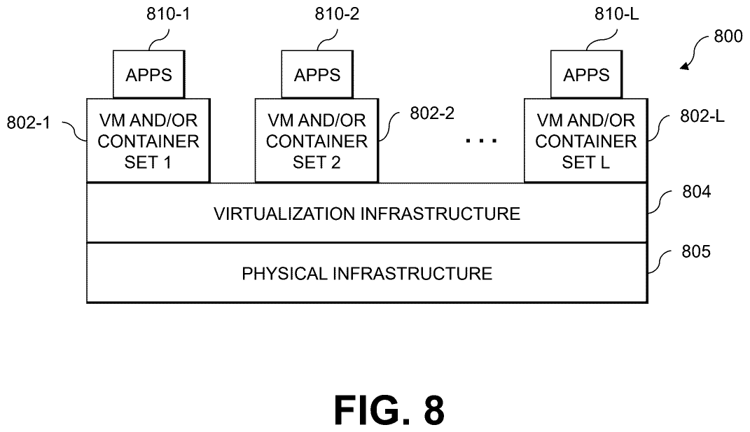

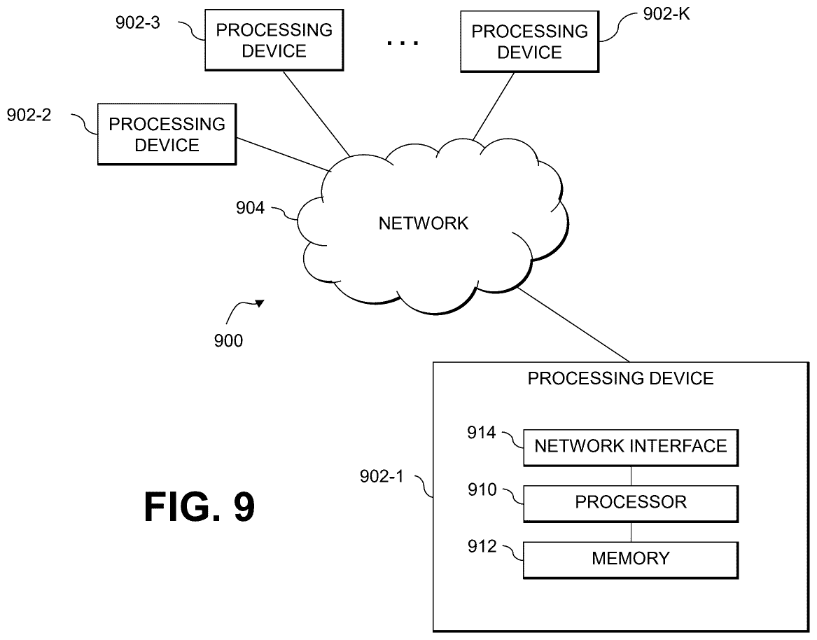

Additional examples of processing platforms utilized to implement the machine learning platform 110 and other components of the information processing system 100 in illustrative embodiments will be described in more detail below in conjunction with FIGS. 8 and 9.

It is to be understood that the particular set of elements shown in FIG. 1 for machine learning-based processing of environmental data using temporal dynamics and spatial awareness information is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

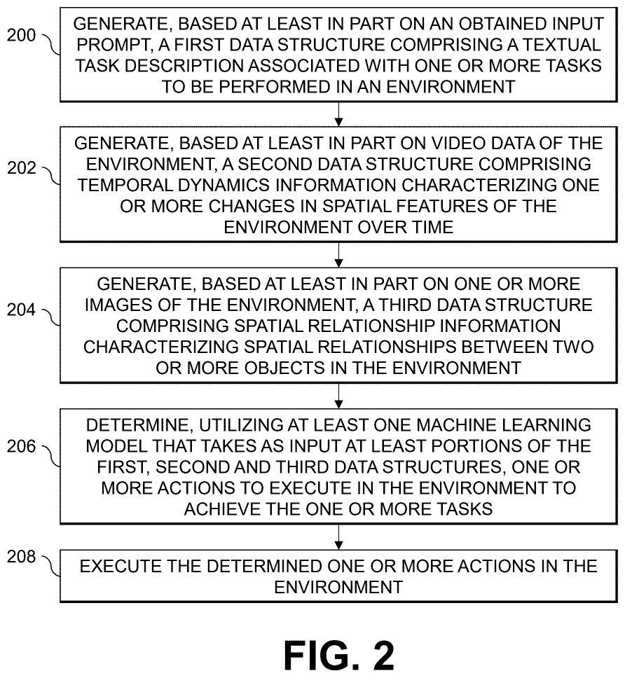

An exemplary process for machine learning-based processing of environmental data using temporal dynamics and spatial awareness information will now be described in more detail with reference to the flow diagram of FIG. 2. It is to be understood that this particular process is only an example, and that additional or alternative processes for machine learning-based processing of environmental data using temporal dynamics and spatial awareness information may be used in other embodiments.

In this embodiment, the process includes steps 200 through 208. These steps are assumed to be performed by the machine learning platform 110 utilizing the multi-modal AI tool 112, the temporal dynamics analysis logic 114, the spatial awareness analysis logic 116, the temporal dynamics and spatial awareness feature encoding logic 118, and the action plan generation and execution logic 120. The process begins with step 200, generating, based at least in part on an obtained input prompt, a first data structure comprising a textual task description associated with one or more tasks to be performed in an environment. The input prompt may comprise a user prompt from a user that is in or is interacting with the environment, such as a text-based prompt, an audio-based prompt (e.g., which may be processed using speech-to-text conversion algorithms), combinations thereof, etc. The first data structure may be generated by applying one or more natural language processing (NLP) algorithms to the obtained input prompt. In some embodiments, the environment is a physical environment, and the one or more tasks to be performed include navigation of an autonomous vehicle from a source location to a destination location in the physical environment, movement of robotic equipment to manipulate objects in the physical environment, etc. In other embodiments, the environment is a virtual environment such as an augmented reality (AR) or virtual reality (VR) environment, and the one or more tasks to be performed include manipulation of objects in the virtual environment.

In step 202, a second data structure is generated based at least in part on video data of the environment. The second data structure comprises temporal dynamics information characterizing one or more changes in spatial features of the environment over time. Step 202 may include processing a sequence of two or more frames in the video data using a convolutional neural network (CNN) machine learning model to extract feature vectors encapsulating spatial information of the environment, and processing the extracted feature vectors using a recurrent neural network (RNN) machine learning model to determine a set of hidden states representing temporal evolution of the spatial features. The RNN machine learning model may comprise one or more long short term memory (LSTM) units. Step 202 may further comprise utilizing a classifier to map the temporal evolution of the spatial features to action labels, and determining event segmentation by identifying changes in the spatial features based at least in part on differences between consecutive ones of the hidden states in the set of hidden states. Step 202 may further comprise utilizing a temporal relation network (TRN) to identify relationships between events based on analysis of pairs of the hidden states in the set of hidden states.

In step 204, a third data structure is generated based at least in part on one or more images of the environment. The third data structure comprises spatial relationship information characterizing spatial relationships between two or more objects in the environment. In some embodiments, the one or more images of the environment are extracted from the video data (e.g., one or more frames of the video data) that is used in generating the second data structure in step 202. In other embodiments, the one or more images of the environment may be captured from one or more cameras or other imaging sensors different from the cameras or imaging sensors used to capture the video data used in generating the second data structure in step 202. Step 204 may comprise processing the one or more images of the environment utilizing a CNN machine learning model to extract feature maps comprising two-dimensional pixel coordinates and associated depth values, and performing three-dimensional (3D) scene reconstruction of the environment utilizing a back-projection algorithm that translates the two-dimensional (2D) pixel coordinates and the associated depth values into 3D coordinates relative to a position of a camera in the environment, the back-projection algorithm being based at least in part on a set of camera parameters of the camera, the set of camera parameters comprising focal length and optical center. Step 204 may further comprise performing object detection by applying a region proposal network (RPN) to the extracted feature maps to detect the two or more objects in the environment, and applying a graph neural network (GNN) machine learning model to classify and localize the two or more objects within the environment. Step 204 may further comprise utilizing a spatial relationship graph (SRG) that takes as input object information for the two or more objects in the environment and the 3D coordinates of the scene to determine spatial relationships between pairs of the two or more objects. The spatial relationship graph may be generated utilizing a GNN machine learning model.

In step 206, at least one machine learning model that takes as input at least portions of the first, second and third data structures is used to determine one or more actions to execute in the environment to achieve the one or more tasks. The determined one or more actions are executed in the environment in step 208. The at least one machine learning model may comprise an MLLM implementing an attention mechanism that is configured to evaluate the significance of one or more words and phrases in the textual task description in the context of the temporal dynamics information and the spatial relationship information.

It should be noted that the term “data structure” as used herein is intended to be broadly construed. A data structure, such as any single one of or combination of the first, second and third data structures referred to above, may provide a portion of a larger data structure, or any one of or combination of the first, second and third data structures may be combinations of multiple smaller data structures. Therefore, the first, second and third data structures referred to above may be different parts of a same overall data structure, or one or more of the first, second and third data structures could be made up of multiple smaller data structures. The data structures may include tables, vectors, embeddings, or various other data structures. In some embodiments, the data structures are specifically formatted or generated such that they are suitable for use as at least one of an input to and an output from a machine learning model. It should further be appreciated that “generating” a data structure may encompass, for example, populating an existing or previously-created data structure with one or more data items.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In the field of artificial intelligence (AI), traditional language models are often constrained by their inability to interact with and understand complex environments. In conventional approaches, textual data is processed without considering the rich context provided by real-world visual cues, leading to a disconnect between the AI's decision-making capabilities and the dynamic physical context. To address these and other technical problems, illustrative embodiments utilize an Embodied AI framework (e.g., an Embodied Large Language Model (LLM)) that bridges this gap by incorporating advanced temporal dynamics and spatial awareness, facilitating a more holistic understanding of environmental context for action planning.

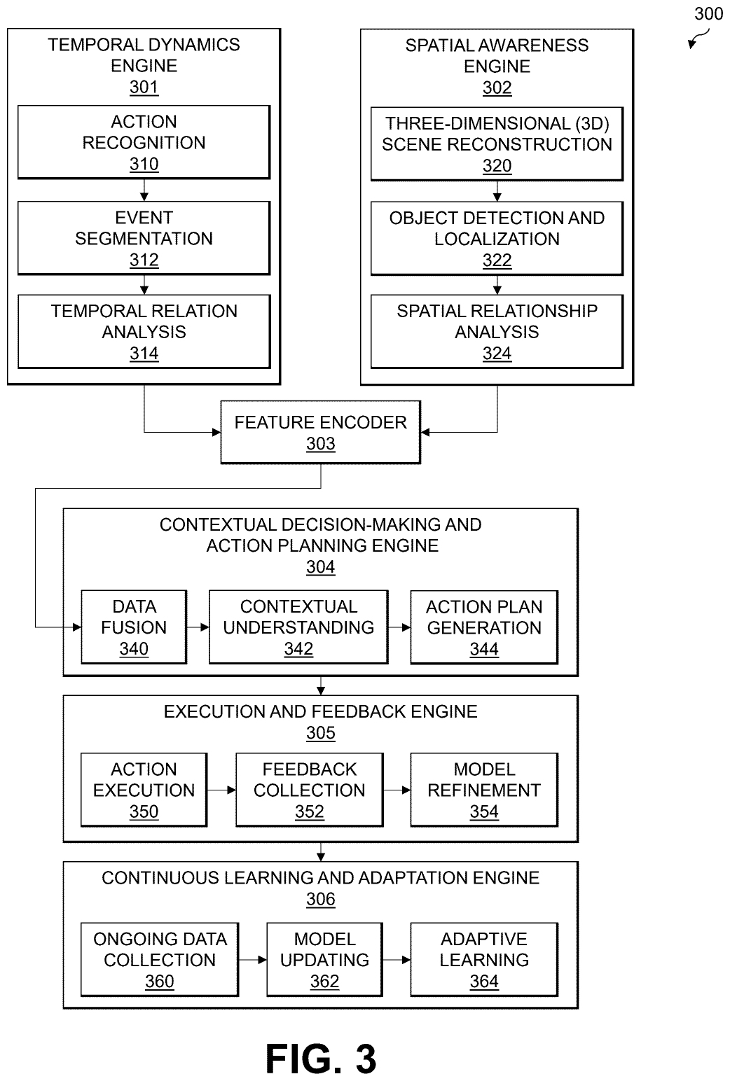

FIG. 3 shows a system 300 implementing an Embodied AI framework. The system 300 includes a temporal dynamics engine 301, a spatial awareness engine 302, a feature encoder 303, a contextual decision-making and action planning engine 304, an execution and feedback engine 305, and a continuous learning and adaptation engine 306. The temporal dynamics engine 301 is configured to perform action recognition 310, event segmentation 312 and temporal relation analysis 314. The spatial awareness engine 302 is configured to perform three-dimensional (3D) scene reconstruction 320, object detection and localization 322, and spatial relationship analysis 324. The outputs of the temporal relation analysis 314 and the spatial relationship analysis 324 are provided to the feature encoder 303, with the resulting encoded features being provided to the contextual decision-making and action planning engine 304. The contextual decision-making and action planning engine 304 is configured to perform data fusion 340, contextual understanding 342 and action plan generation 344. The results of the action plan generation 344 (e.g., one or more action plans) are provided to the execution and feedback engine 305. The execution and feedback engine 305 is configured to perform action execution 350, feedback collection 352 and model refinement 354. The continuous learning and adaptation engine 306 is configured to perform ongoing data collection 360, model updating 362 and adaptive learning 364. The feature encoder 303 is configured to encode and integrate the temporal dynamics and spatial awareness features extracted using the temporal dynamics engine 301 and the spatial awareness engine 302 with an AI model (e.g., an LLM) for context-aware decision-making. The model's output informs action planning, which is refined through feedback and adaptive learning mechanisms.

The Embodied AI framework shown in the system 300 is configured to encode realistic environmental information from images and videos, and to use this data to enhance action planning for complex tasks. Video and image analysis techniques are utilized to analyze temporal dynamics in the temporal dynamics engine 301 in order to capture the evolution of the environment over time. Simultaneously, the spatial awareness engine 302 is configured to utilize spatial awareness algorithms to understand the physical layout and relationships within a given space. These dual aspects (temporal relations and spatial relationships) are encoded by the feature encoder 303, and seamlessly integrated with natural language processing (NLP) models which, in some embodiments, leverage an attention mechanism that highlights the most pertinent information for any given task. The feedback loop integrated within the Embodied AI framework of the system 300 (e.g., the execution and feedback engine 305 and the continuous learning and adaptation engine 306) enables system actions to be dynamically updated based on real-world outcomes.

The Embodied AI framework of the system 300 advantageously integrates temporal dynamics and spatial awareness analysis for rich environmental encoding. In some embodiments, an advanced attention mechanism is leveraged to synergize visual and textual data, enhancing the relevance and precision of action plans. Continuous learning and adaptation capabilities are used to refine decision-making processes through real-time feedback. The Embodied AI framework of the system 300 may be utilized in various real-world scenarios, including robotics, augmented reality (AR), etc., and provides significant advancements over language-only models through providing a robust framework for sophisticated environmental interaction and task execution.

Embodied AI aims to endow artificial agents with the ability to perceive, understand and interact with complex and dynamic environments. Embodied AI involves the integration of multiple modalities, such as vision, language, and action, to achieve natural and effective communication and collaboration with humans and other agents.

Temporal dynamics refers to the analysis of how an environment changes over time, and how the agent adapts to these changes. Temporal dynamics is important for embodied AI, as it enables the agent to capture the causal and sequential relationships among events, to reason about the past and future states of the environment, and to plan actions accordingly. One of the challenges of temporal dynamics analysis is to deal with the high-dimensional and noisy data from video streams. Various techniques may be used to extract meaningful and compact representations from videos, including through the use of machine learning models such as convolutional neural network (CNN) models, recurrent neural network (RNN) models, and transformers-based models. These models can learn to encode both spatial and temporal features from videos, such as object appearance, motion and scene context. Another technical challenge in temporal dynamics analysis is the incorporation of prior knowledge and common sense into the model. In some embodiments, physical laws, intuitive physics and causal inference are used to enhance the model's ability to predict and explain the behavior of objects and agents in the environment. These methods can help the model to handle uncertainty, ambiguity and counterfactual scenarios.

Spatial awareness refers to the understanding of the spatial layout and relationships of the environment and the agent. Spatial awareness is important for embodied AI, as it enables the agent to navigate the environment, locate and manipulate objects, and coordinate with other agents. One of the technical challenges of spatial awareness is to represent and reason about the 3D structure and geometry of the environment. Various methods may be used to reconstruct the 3D environment from two-dimensional (2D) images, such as voxel grids, point clouds, and meshes. These methods can learn to infer the shape, size and pose of objects and scenes from images, and to generate realistic and detailed 3D models. Another technical challenge of spatial awareness is to infer and express the spatial relations and references among objects and agents. In some embodiments, scene graphs, spatial attention and spatial language are used to enhance the model's ability to describe and communicate the spatial information of the environment. These methods can help the model to capture the semantic and pragmatic aspects of spatial awareness, such as attributes, categories and perspectives.

Multi-modal large language models (MLLMs) are an extension of LLMs that can process and generate multi-modal data, such as text, images and videos. MLLMs are powerful tools for embodied AI, as they can leverage the massive and diverse data from multiple modalities to learn general and transferable representations and skills. One of the technical challenges of MLLMs is to align and fuse the information from different modalities. Various methods may be used to achieve cross-modal alignment and fusion, including co-attention, cross-modal transformers, and cross-modal pre-training. These methods can learn to attend to the relevant information from each modality, and to integrate them into a coherent and comprehensive representation. Another technical challenge of MLLMs is to apply them to various downstream tasks and scenarios. Various methods may be used to adapt and fine-tune MLLMs to specific domains and applications, such as visual question answering, image captioning, and embodied navigation. These methods can leverage the general knowledge and skills learned by MLLMs, and tailor them to the task and data at hand.

Embodied AI seeks to create agents that can understand and interact with their environment in a manner akin to humans. Despite significant advances, several technical challenges remain. Such technical challenges, include: how to effectively analyze and encode temporal dynamics from high-dimensional and noisy video data to capture the causal and sequential relationships among events within an environment; how to incorporate prior knowledge and intuitive physics into the model to enhance its predictive capabilities and handle uncertainty and counterfactuals; how to develop a representation and reasoning system for the spatial awareness required for navigation, object manipulation and coordination in 3D space; how to infer and express complex spatial relations and references that are understandable and usable by both AI agents and humans; how to align and fuse multi-modal information from disparate sources such as text, images and videos into a coherent representation for decision making; and how to adapt and fine-tune MLLMs to specific downstream tasks that require a deep understanding of the environment. These and other technical challenges are resolved at least in part by the technical solutions described herein, which enable the creation of an Embodied AI framework (e.g., an Embodied LLM) that can perceive, understand and interact with its environment dynamically and intelligently.

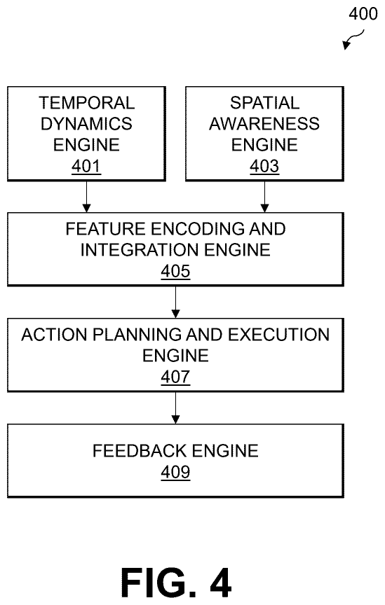

FIG. 4 shows an architecture 400 of an Embodied AI model (e.g., an Embodied LLM) that is designed to perceive, understand and interact with dynamic environments. The Embodied AI model leverages the integration of temporal dynamics, spatial awareness and multi-modal data processing to enable complex action planning. The architecture 400 includes a temporal dynamics engine 401, a spatial awareness engine 403, a feature encoding and integration engine 405, an action planning and execution engine 407 and a feedback engine 409, which are responsible for processing different aspects of environmental data and contribute to the model's overall decision-making capability. The architecture 400 shown in FIG. 4 illustrates the flow from the processing of temporal and spatial data to action planning and feedback-driven refinement.

The temporal dynamics engine 401 is configured to capture and interpret changes within the environment over time. In some embodiments, the temporal dynamics engine 401 employs advanced neural network architectures to extract temporal features from video streams, identify actions, segment events, and analyze causal relationships among these events. The spatial awareness engine 403 is configured to interpret the physical layout and spatial relationships within the environment. In some embodiments, the spatial awareness engine 403 reconstructs 3D scenes from 2D images, and identifies objects and their spatial relations, providing a comprehensive understanding of the agent's surroundings. The feature encoding and integration engine 405 is configured to process the temporal and spatial data from the temporal dynamics engine 401 and the spatial awareness engine 403, and to encode temporal dynamics and spatial awareness features into a unified representation. In some embodiments, the feature encoding and integration engine 405 is configured to integrate the encoded data using an attention mechanism that aligns with the task-specific textual data, forming a comprehensive representation for decision-making. The action planning and execution engine 407 is configured to use the integrated data produced by the feature encoding and integration engine 405 in the action planning process, where the model generates and executes action plans. The feedback engine 409 is configured to use feedback determined from execution of the action plans to refine the model, ensuring continuous learning and adaptation to the environment.

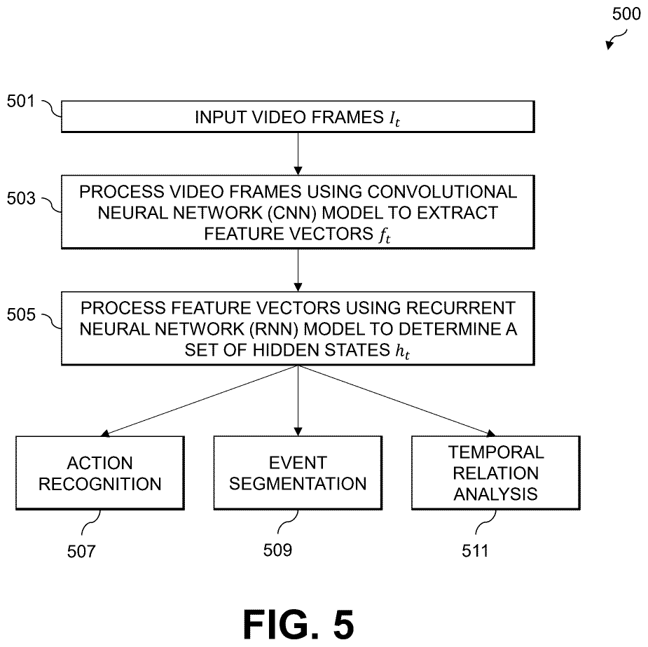

The temporal dynamics engine 401 is tasked with understanding the temporal aspects of the environment by analyzing video data. The temporal dynamics engine 401, in some embodiments, utilizes CNNs to extract spatial features and RNNs or transformers to capture temporal dependencies. FIG. 5 shows a system flow 500 which may be performed utilizing the temporal dynamics engine 401. The temporal dynamics engine 401 operates on sequences of video frames

$${\{ {I}_{t} \}}_{t = 1}^{T} ,$$

where Iₜ represents the frame at time t, and T is the total number of frames. The system flow 500 begins in block 501 with an input of video frames Iₜ. In block 503, the video frames are processed using a CNN model to extract feature vectors fₜ, which encapsulate spatial information. The CNN model processes each of the frames independently. The feature vectors fₜ may be determined according to fₜ=CNN(Iₜ). The feature vectors fₜ are then processed in block 505 using an RNN model to determine a set of hidden states

$${\{ {h}_{t} \}}_{t = 1}^{T}$$

representing the temporal evolution of features. In some embodiments, block 505 utilizes a combination of RNN and Long Short Term Memory (LSTM) models. The use of LSTM units incorporated into an RNN can handle long-term dependencies and reduce the vanishing gradient problem, such that the hidden states hₜ are determined according to hₜ=RNN(fₜ, hₜ₋₁). The final hidden state, h_{T}, or a pooled representation of all hidden states, can serve as the temporal feature for an entire video or a sequence of two or more of the input video frames Iₜ. Using the hidden states representing the temporal evolution of features, action recognition is performed in block 507, event segmentation is performed in block 509, and temporal relation analysis is performed in block 511.

For action recognition in block 507, a classifier may be added on top of the RNN, which maps the temporal features to action labels.

Event segmentation in block 509 may be achieved by identifying changes in the temporal feature patterns. A change detection mechanism can be formalized as follows:

$${δ}_{t} = ‖ {h}_{t} - {h}_{t - 1} ‖ , segment if {δ}_{t} > θ$$

where δₜ is the difference between consecutive hidden states hₜ and hₜ₋₁, and θ is a threshold.

Temporal relation analysis in block 511 is used to analyze the relationships between events, and in some embodiments employs a temporal relation network (TRN) which considers pairs or tuples of temporal features:

$${r}_{i , j} = TRN ( {h}_{i} , {h}_{j} ) , ∀ ( i , j ) : i < j$$

where r_{i,j} captures the relationship between events at times i and j. This provides the temporal context required for the model to understand the sequence and timing of events, important for action planning in dynamic environments.

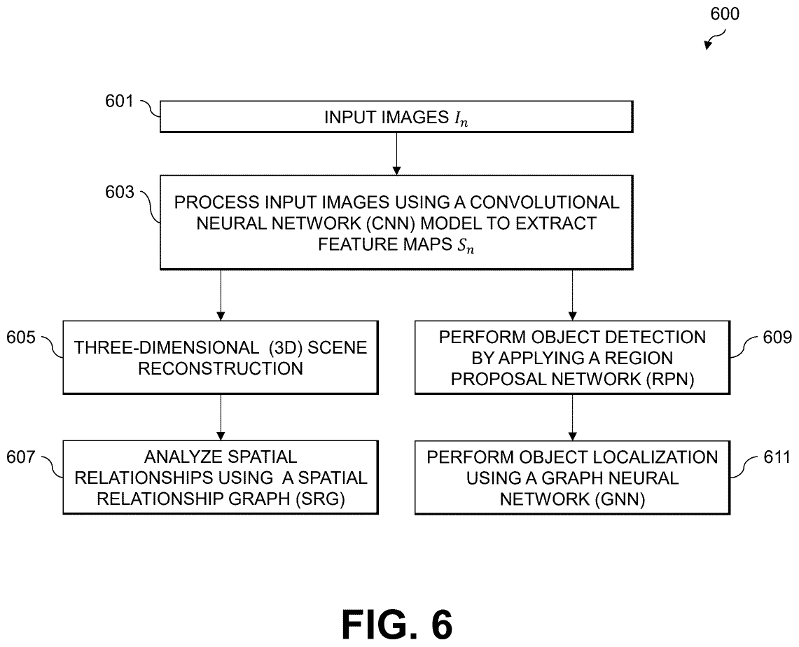

The spatial awareness engine 403 is responsible for comprehending the 3D structure of the environment and the spatial positioning of objects within it. The spatial awareness engine 403 is configured, in some embodiments, to utilize a combination of CNNs and graph neural networks (GNNs) to process 2D images and infer 3D spatial relationships. FIG. 6 shows a system flow 600 which may be performed utilizing the spatial awareness engine 403. The spatial awareness engine 403 operates on a set of images

$${\{ {I}_{n} \}}_{n = 1}^{N} ,$$

where Iₙ denotes the n-th image and N is the total number of images. The system flow 600 begins in block 601 with an input of images Iₙ. In block 603, the input images Iₙ are processed using a CNN model to extract feature maps: Sₙ=CNN(Iₙ).

3D scene reconstruction is performed in block 605, where the features maps are used to infer depth and reconstruct the 3D scene using voxel grid projection or point cloud generation. The 3D reconstructed scene is denoted as [symbol] . To perform the 3D scene reconstruction, depth estimation is carried out for each pixel in the image, resulting a depth map Dₙ. The 3D coordinates (x, y, z) for each pixel can then be obtained through back-projection:

$$( x , y , z ) = BackProject ( {D}_{n} , K )$$

where K represents the camera intrinsic parameters. The back-projection operation translates 2D pixel coordinates and their associated depth values into 3D coordinates relative to a camera's position in space:

$$( x , y , z ) = BackProject ( u , v , D ( u , v ) , K )$$

where (u, v) are the pixel coordinates in the 2D image, D(u, v) is the depth value at pixel (u, v), K is the matrix of intrinsic camera parameters (e.g., which include the focal length, optical center, etc.), and (x, y, z) are the 3D coordinates in the camera's frame of reference. In some embodiments, the conversion is based on the pinhole camera model and is expressed as:

$$[ \begin{matrix}x \\ y \\ z\end{matrix} ] = D ( u , v ) \cdot {K}^{- 1} \cdot [ \begin{matrix}u \\ v \\ 1\end{matrix} ]$$

In block 607, the spatial relationships are analyzed using a Spatial Relationship Graph (SRG), where nodes represent objects and edges represent spatial relationships. The SRG may be constructed as follows:

$$𝒢 = SRG ( 𝒪 , ℛ )$$

where [symbol] is the set of detected objects with their properties such as class labels and bounding box coordinates, [symbol] is the 3D reconstruction of the scene providing spatial context, and [symbol] represents the SRG with vertices V and edges E, where each vertex corresponds to an object and each edge corresponds to a spatial relationship.

The edges can be weighted based on the type and strength of the spatial relationship. The adjacency matrix A of the SRG is given by:

$${A}_{ij} = \{ \begin{matrix}{w}_{ij} & if there is a spatial relationship between i and j \\ 0 & otherwise\end{matrix}$$

where wᵢⱼ is the weight representing the strength or type of the relationship between objects i and j.

The SRG can be mathematically represented as [symbol] =(V, E), where V is the set of vertices corresponding to the objects and E is the set of edges representing the spatial relationships. Each edge eᵢⱼ∈E connecting vertices vᵢ and vⱼ can have an associated weight wᵢⱼ that quantifies the relationship. The generation of the SRG can be formally described with the following equation:

$$𝒢 = SRG ( {\{ {O}_{i} \}}_{i = 1}^{M} , \{ {R}_{ij} \} )$$

where

$${\{ {O}_{i} \}}_{i = 1}^{M}$$

is the set of detected objects in the scene, Rᵢⱼ is the set of spatial relationships between each pair of objects (Oᵢ, Oⱼ), and [symbol] is the resulting SRG.

An example of a relationship Rᵢⱼ could be a binary function indicating the presence of a particular spatial relationship type between objects Oᵢ and Oⱼ:

$${R}_{ij} = \{ \begin{matrix}1 & if a spatial relationship exists between {O}_{i} and {O}_{j} \\ 0 & otherwise\end{matrix}$$

The actual implementation of the SRG generation, in some embodiments, utilizes deep learning models that are trained to recognize and encode spatial relationships from data, possibly enhanced by GNNs that can learn complex patterns in graph-structured data. The SRG provides a comprehensive understanding of the spatial layout, which is important for the Embodied AI framework (e.g., the Embodied LLM) to navigate and interact within the environment.

In block 609, object detection is performed by applying a Region Proposal Network (RPN) to the feature maps. In block 611, object localization is performed using a GNN. In some embodiments, object detection is achieved by applying the RPN to the feature maps followed by a GNN that classifies and localizes objects:

$$𝒪 = GNN ( RPN ( {S}_{n} ) )$$

where O denotes the set of detected objects.

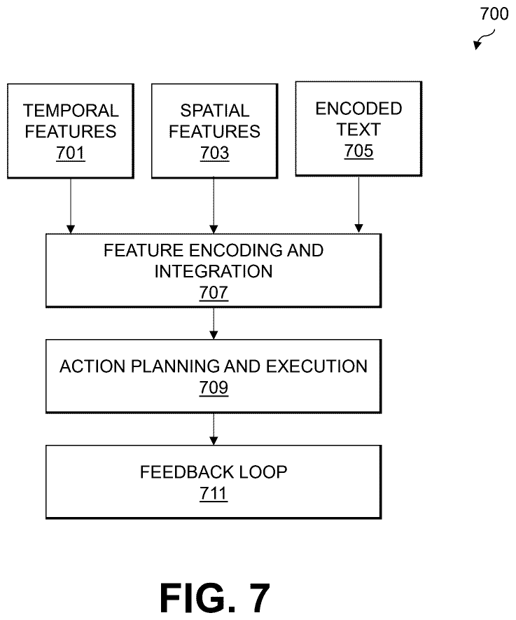

FIG. 7 shows a system flow 700, where temporal features 701 (e.g., obtained from temporal dynamics engine 401) and spatial features 703 (e.g., obtained from spatial awareness engine 403) along with encoded text 705 (e.g., an input text prompt or other textual data) are provided for feature encoding and integration in block 707. The feature encoding and integration in block 707 serves as a convergence point, and may utilize an attention mechanism to effectively combine the temporal features 701 and the spatial features 703 with task-specific textual descriptions in the encoded text 705, which leads to plan generation in the action planning and execution block 709 and feedback-driven refinement in block 711.

The attention mechanism for textual integration used in some embodiments will now be described. To integrate the spatial and temporal information with the textual task descriptions, a text-focused attention mechanism may be utilized which evaluates the significance of each word or phrase in the context of the spatial and temporal descriptions. Given a sequence of encoded words

$${\{ {w}_{t} \}}_{t = 1}^{T}$$

from the textual task descriptions and encoded spatial and temporal descriptions

$${\{ {e}_{s} \}}_{s = 1}^{S} and {\{ {e}_{t} \}}_{t = 1}^{T} ,$$

the attention mechanism computes a context vector cₜ for each time step:

$${α}_{ts} = \frac{exp ( score ( {h}_{t} , {e}_{s} ) )}{{\sum }_{{s}^{′}} exp ( score ( {h}_{t} , {e}_{{s}^{′}} ) )} ,$$

$${c}_{t} = {\sum }_{s} {α}_{ts} {e}_{s}$$

where hₜ is the hidden state of the LLM at time t corresponding to the word wₜ, eₛ is the encoded spatial or temporal description, αₜₛ is the attention weight reflecting the importance of the environmental description eₛ for the word wₜ, and score(·) is a scoring function that measures the compatibility of hₜ with eₛ. The scoring function may be implemented using a simple dot product, a neural network, etc.

The context vectors cₜ are then concatenated with the hidden states hₜ to inform the generation of action plans:

$${h}_{t}^{′} = [ {h}_{t} ; {c}_{t} ]$$

This concatenated representation provides a rich context that blends environmental descriptions with the textual task description, enabling the LLM to generate informed and relevant actions.

The action planning and execution in block 709 is the culmination of the process, where the Embodied LLM utilizes the integrated representation to generate actionable plans. Action plans are generated through a decision-making algorithm that maps the integrated representation to a sequence of actions:

$$P = Decide ( {c}_{integrated} )$$

where c_{integrated} is the integrated feature representation and P is the set of action plans.

The generated plans are executed within the environment, and feedback is collected to assess the outcomes:

$$F = Execute ( P )$$

where F represents the feedback data from execution. The feedback is then used in the feedback loop in block 711 to update and refine the model, facilitating continuous learning and adaptation to the environment. This completes the architecture of the Embodied LLM, enabling sophisticated interaction with complex environments for a wide range of applications.

The Embodied AI frameworks (e.g., Embodied LLMs) described herein advantageously integrate temporal dynamics, spatial awareness and textual information for intelligent decision-making and action planning. The integrated temporal and spatial analysis allows the model to uniquely process and encode both temporal dynamics from video data and spatial information from 3D scene reconstructions. This dual analysis provides a comprehensive understanding of the environment, capturing both the evolution of scenarios over time and the intricate spatial relationships. The technical solutions in some embodiments further utilize a text-centric attention mechanism, which is a specialized attention mechanism that focuses on integrating textual task descriptions with encoded spatial and temporal features. This approach allows the LLM to selectively prioritize information based on the task's context, enhancing the relevance and accuracy of its outputs. The technical solutions further provide an innovative use of GNNs in spatial relationship analysis and the construction of SRGs. In some embodiments, this allows for a more nuanced understanding and representation of spatial relationships, which is useful for tasks involving navigation and objection manipulation. These innovations collectively contribute to the technical solutions for implementing an advanced Embodied AI framework that enables a more intelligent, context-aware and adaptable AI system capable of understanding and interacting with their environments in a human-like manner.

The technical solutions described herein provide a novel Embodied AI framework (e.g., an Embodied LLM) that integrates temporal dynamics, spatial awareness and textual information for intelligent decision-making in dynamic environments. The technical solutions mark a significant advancement for embodied AI, addressing critical technical challenges that have limited previous models. The technical solutions advantageously allow for the integration of multi-modal data, the development of a text-centric attention mechanism, and the incorporation of continuous learning, setting a new standard for intelligent systems capable of complex environmental interaction.

The technical solutions described herein can be leveraged in various use cases, including extending the technology beyond the realm of conventional AI applications. With the ability to understand and interpret the environment in a holistic manner, the Embodied AI framework (e.g., the Embodied LLM) opens up new possibilities in various fields, such as robotics, autonomous vehicles, virtual assistants, AR and interactive entertainment. The Embodied AI framework can revolutionize how machines perceive, interpret and interact with the world, bridging the gap between AI and human-like understanding. Further, the adaptability and learning capabilities of the model ensures its applicability in a wide range of scenarios, including those with changing or unpredictable environments. This flexibility makes the Embodied AI framework a robust solution for real-world applications where variability and complexity are the norms. The Embodied AI framework provides technical advancements enabling truly intelligent and interactive AI systems. Its ability to seamlessly integrate and interpret multi-modal data, adapt to new environments and make informed decisions positions the Embodied AI frameworks described herein as a pioneering solution in the journey towards advanced, context-aware AI.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based processing of environmental data using temporal dynamics and spatial awareness information will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100 in FIG. 1. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based processing of environmental data using temporal dynamics and spatial awareness information as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate, based at least in part on an obtained input prompt, a first data structure comprising a textual task description associated with one or more tasks to be performed in an environment;
to generate, based at least in part on video data of the environment, a second data structure comprising temporal dynamics information characterizing one or more changes in spatial features of the environment over time;
to generate, based at least in part on one or more images of the environment, a third data structure comprising spatial relationship information characterizing spatial relationships between two or more objects in the environment;
to determine, utilizing at least one machine learning model that takes as input at least portions of the first, second and third data structures, one or more actions to execute in the environment to achieve the one or more tasks; and
to execute the determined one or more actions in the environment.

2. The apparatus of claim 1 wherein generating the first data structure comprises applying one or more natural language processing algorithms to the obtained input prompt.

3. The apparatus of claim 1 wherein generating the second data structure comprises:
processing a sequence of two or more frames in the video data using a convolutional neural network machine learning model to extract feature vectors encapsulating spatial information of the environment; and
processing the extracted feature vectors using a recurrent neural network machine learning model to determine a set of hidden states representing temporal evolution of the spatial features.

4. The apparatus of claim 3 wherein the recurrent neural network machine learning model comprises one or more long short term memory units.

5. The apparatus of claim 3 wherein generating the second data structure further comprises:
utilizing a classifier to map the temporal evolution of the spatial features to action labels; and
determining event segmentation by identifying changes in the spatial features based at least in part on differences between consecutive ones of the hidden states in the set of hidden states.

6. The apparatus of claim 3 wherein generating the second data structure further comprises utilizing a temporal relation network to identify relationships between events based on analysis of pairs of the hidden states in the set of hidden states.

7. The apparatus of claim 1 wherein generating the third data structure comprises:
processing the one or more images of the environment utilizing a convolutional neural network machine learning model to extract feature maps comprising two-dimensional pixel coordinates and associated depth values; and
performing three-dimensional scene reconstruction of the environment utilizing a back-projection algorithm that translates the two-dimensional pixel coordinates and the associated depth values into three-dimensional coordinates relative to a position of a camera in the environment, the back-projection algorithm being based at least in part on a set of camera parameters of the camera, the set of camera parameters comprising focal length and optical center.

8. The apparatus of claim 7 wherein generating the third data structure further comprises:
performing object detection by applying a region proposal network to the extracted feature maps to detect the two or more objects in the environment; and
applying a graph neural network machine learning model to classify and localize the two or more objects within the environment.

9. The apparatus of claim 7 wherein generating the third data structure further comprises utilizing a spatial relationship graph that takes as input object information for the two or more objects in the environment and the three-dimensional coordinates of the environment to determine spatial relationships between pairs of the two or more objects.

10. The apparatus of claim 9 wherein the spatial relationship graph is generated utilizing a graph neural network machine learning model.

11. The apparatus of claim 1 wherein the at least one machine learning model comprises a multi-modal large language model implementing an attention mechanism configured to evaluate the significance of one or more words and phrases in the textual task description in the context of the temporal dynamics information and the spatial relationship information.

12. The apparatus of claim 1 wherein the environment comprises a physical environment, and wherein the one or more tasks to be performed in the environment comprises navigation of an autonomous vehicle from a source location to a destination location in the physical environment.

13. The apparatus of claim 1 wherein the environment comprises a physical environment, and wherein the one or more tasks to be performed in the environment comprises movement of robotic equipment to manipulate at least one of the two or more objects in the physical environment.

14. The apparatus of claim 1 wherein the environment comprises an augmented reality or virtual reality environment, and wherein the one or more tasks to be performed in the environment comprises manipulation of at least one of the two or more objects in the augmented reality or virtual reality environment.

15. A computer program product comprising a non-transitory processor-readable storage medium having stored therein program code of one or more software programs, wherein the program code when executed by at least one processing device causes the at least one processing device:
to generate, based at least in part on an obtained input prompt, a first data structure comprising a textual task description associated with one or more tasks to be performed in an environment;
to generate, based at least in part on video data of the environment, a second data structure comprising temporal dynamics information characterizing one or more changes in spatial features of the environment over time;
to generate, based at least in part on one or more images of the environment, a third data structure comprising spatial relationship information characterizing spatial relationships between two or more objects in the environment;
to determine, utilizing at least one machine learning model that takes as input at least portions of the first, second and third data structures, one or more actions to execute in the environment to achieve the one or more tasks; and
to execute the determined one or more actions in the environment.

16. The computer program product of claim 15 wherein generating the second data structure comprises:
processing a sequence of two or more frames in the video data using a convolutional neural network machine learning model to extract feature vectors encapsulating spatial information of the environment; and
processing the extracted feature vectors using a recurrent neural network machine learning model to determine a set of hidden states representing temporal evolution of the spatial features.

17. The computer program product of claim 15 wherein generating the third data structure comprises:
processing the one or more images of the environment utilizing a convolutional neural network machine learning model to extract feature maps comprising two-dimensional pixel coordinates and associated depth values; and
performing three-dimensional scene reconstruction of the environment utilizing a back-projection algorithm that translates the two-dimensional pixel coordinates and the associated depth values into three-dimensional coordinates relative to a position of a camera in the environment, the back-projection algorithm being based at least in part on a set of camera parameters of the camera, the set of camera parameters comprising focal length and optical center.

18. A method comprising:
generating, based at least in part on an obtained input prompt, a first data structure comprising a textual task description associated with one or more tasks to be performed in an environment;
generating, based at least in part on video data of the environment, a second data structure comprising temporal dynamics information characterizing one or more changes in spatial features of the environment over time;
generating, based at least in part on one or more images of the environment, a third data structure comprising spatial relationship information characterizing spatial relationships between two or more objects in the environment;
determining, utilizing at least one machine learning model that takes as input at least portions of the first, second and third data structures, one or more actions to execute in the environment to achieve the one or more tasks; and
executing the determined one or more actions in the environment;
wherein the method is performed by at least one processing device comprising a processor coupled to a memory.

19. The method of claim 18 wherein generating the second data structure comprises:
processing a sequence of two or more frames in the video data using a convolutional neural network machine learning model to extract feature vectors encapsulating spatial information of the environment; and
processing the extracted feature vectors using a recurrent neural network machine learning model to determine a set of hidden states representing temporal evolution of the spatial features.

20. The method of claim 18 wherein generating the third data structure comprises:
processing the one or more images of the environment utilizing a convolutional neural network machine learning model to extract feature maps comprising two-dimensional pixel coordinates and associated depth values; and
performing three-dimensional scene reconstruction of the environment utilizing a back-projection algorithm that translates the two-dimensional pixel coordinates and the associated depth values into three-dimensional coordinates relative to a position of a camera in the environment, the back-projection algorithm being based at least in part on a set of camera parameters of the camera, the set of camera parameters comprising focal length and optical center.
